(19) United States
(12) Patent Application Publication
(10) Pub. No.: US 2026/0070336 A1
(43) Pub. Date: Mar. 12, 2026

(54) LIQUID EJECTION APPARATUS CAPABLE OF SUPPRESSING TEMPERATURE DROP OF HUMIDIFIED AIR SUPPLIED TO SEALED SPACE ALONG NOZZLE SURFACE

(71) Applicant: KYOCERA Document Solutions Inc., Osaka-shi, Osaka (JP)

(72) Inventors: Yiquan Nie, Osaka (JP); Takashi Somete, Osaka (JP)

(21) Appl. No.: 19/316,701

(22) Filed: Sep. 2, 2025

(30) Foreign Application Priority Data
Sep. 6, 2024 (JP) 2024-153683

(51) Int. Cl. B41J 2/165

(52) U.S. Cl. CPC B41J 2/16508; B41J 2/16535; B41J 2002/16564; B41J 2002/16594

(57) ABSTRACT

A liquid ejection apparatus includes a sealing portion, a heater, a path forming portion, and a pump. The sealing portion seals a space along a nozzle surface. The heater heats water stored in a tank. The path forming portion forms a movement path for air to move from a first opening portion that opens above a water surface of the tank, through the sealed space sealed by the sealing portion, to a second opening portion that opens below the water surface. The pump moves air in the movement path in a direction from the first opening portion to the second opening portion. The first opening portion and the second opening portion are arranged in a positional relationship such that the first opening portion faces a specific range on the water surface to which air discharged from the second opening portion rises.

### INCORPORATION BY REFERENCE

This application is based upon and claims the benefit of priority from the corresponding Japanese Patent Application No. 2024-153683 filed on Sep. 6, 2024, the entire contents of which are incorporated herein by reference.

### BACKGROUND

The present disclosure relates to a liquid ejection apparatus.

A liquid ejection apparatus such as an inkjet printer includes an ejection portion and a sealing portion. The ejection portion has a nozzle surface in which nozzles are formed, and ejects ink from the nozzles. The sealing portion seals a space along the nozzle surface

In addition, a liquid ejection apparatus capable of supplying humidified air into a sealed space sealed by the sealing portion is known as related art. More specifically, the liquid ejection apparatus according to the related art includes a tank, a heater, a path forming portion, and a pump. The tank stores water. The heater heats the water stored in the tank. The path forming portion forms a movement path for air to move from a first opening portion that opens above a water surface of the water stored in the tank, through the sealed space, to a second opening portion that opens below the water surface. The pump moves air in the movement path in a direction from the first opening portion to the second opening portion. In the liquid ejection apparatus of the related art, the pump is driven to discharge air from the second opening portion, the air is then heated and humidified in the water and by rising above the water surface, humidified air is generated.

### SUMMARY

A liquid ejection apparatus according to the present disclosure includes an ejection portion, a sealing portion, a tank, a heater, a path forming portion, and a pump. The ejection portion has a nozzle surface on which nozzles are formed, and ejects liquid from the nozzles. The sealing portion seals a space along the nozzle surface The tank stores water. The heater heats the water stored in the tank. The path forming portion forms a movement path for air to move from a first opening portion that opens above a water surface of the water stored in the tank, through a sealed space sealed by the sealing portion, to a second opening portion that opens below the water surface. The pump moves air in the movement path in a direction from the first opening portion toward the second opening portion. The first opening portion and the second opening portion are arranged in a positional relationship such that the first opening portion faces a specific range on the water surface to which air discharged from the second opening portion rises.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a cross-sectional view showing a configuration of an image forming apparatus of an embodiment according to the present disclosure.

FIG. 2 is a perspective view showing a configuration of a head unit of an image forming apparatus of an embodiment according to the present disclosure.

FIG. 3 is a perspective view showing a configuration of a cap unit of an image forming apparatus of an embodiment according to the present disclosure.

FIG. 4 is a cross-sectional view showing a configuration of a humidifying portion of an image forming apparatus of an embodiment according to the present disclosure.

FIG. 5 is a cross-sectional view showing a modification of a humidifying portion of an image forming apparatus of an embodiment according to the present disclosure.

### DETAILED DESCRIPTION

Hereinafter, embodiments according to the present disclosure will be described with reference to the accompanying drawings. Note that the following embodiments are examples according to the present disclosure and do not limit the technical scope of the present disclosure.

### Configuration of Image Forming Apparatus 100

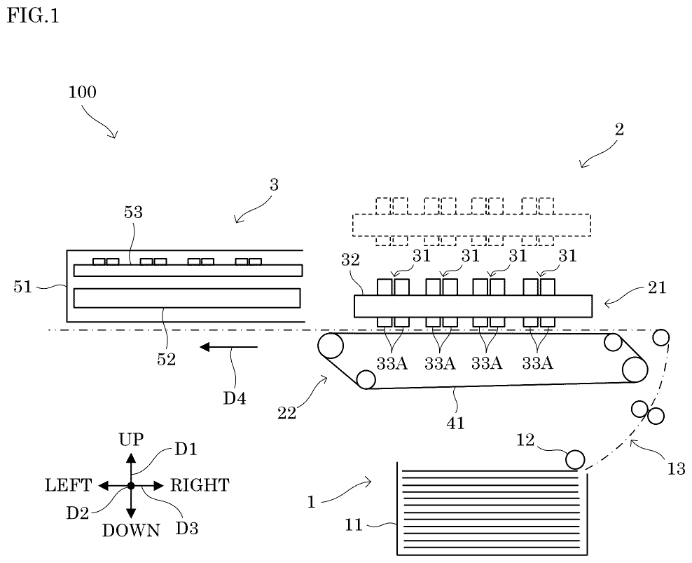

First, a configuration of an image forming apparatus 100 of an embodiment of the present disclosure will be described with reference to FIGS. 1 to 3.

Note that for ease of explanation, the vertical direction in an installed state in which the image forming apparatus 100 is usable (state shown in FIG. 1) is defined as an up-down direction D1. In addition, a front-rear direction D2 is defined with the surface on the front side of the paper of the image forming apparatus 100 shown in FIG. 1 taken to be the front surface (front). Further, a left-right direction D3 is defined based on the front surface of the image forming apparatus 100 in the installed state.

The image forming apparatus 100 is an inkjet printer capable of forming an image on a sheet by an inkjet method. The image forming apparatus 100 is an example of a liquid ejection apparatus according to the present disclosure. In addition, ink is an example of a liquid according to the present disclosure.

As shown in FIG. 1, the image forming apparatus 100 includes a sheet feed portion 1, an image forming portion 2, and a maintenance portion 3.

The sheet feed portion 1 supplies sheets to the image forming portion 2.

As shown in FIG. 1, the sheet feed portion 1 includes a sheet feed cassette 11 and a sheet feed unit 12. The sheet feed cassette 11 stores sheets on which images are to be formed by the image forming portion 2. The sheet feed unit 12 takes out the topmost sheet of a plurality of sheets (stack of sheets) stored in the sheet feed cassette 11, and conveys the taken-out sheet to a downstream side of a conveying path 13 (see FIG. 1). In the image forming apparatus 100, a sheet is conveyed along a conveying path 13 (see FIG. 1) that passes from the sheet feed cassette 11 via the image forming portion 2. In FIG. 1, the conveying path 13 is indicated by a single dotted line.

The image forming portion 2 forms an image on the sheet fed by the sheet feed portion 1 using an inkjet method.

As shown in FIG. 1, the image forming portion 2 includes a head unit 21 and a conveying unit 22.

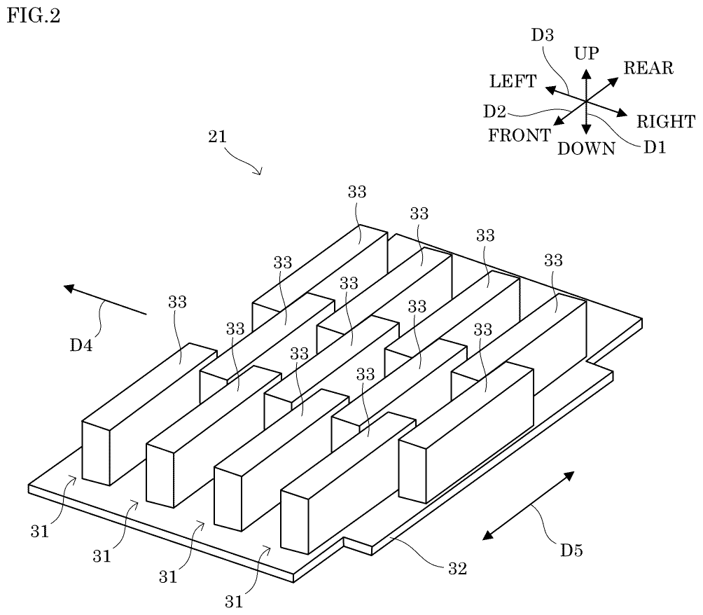

As shown in FIGS. 1 and 2, the head unit 21 includes four line heads 31 and a support portion 32.

As shown in FIG. 2, each line head 31 is elongated in a width direction D5 (see FIG. 2) (the same direction as the front-rear direction D2) perpendicular to a conveying direction D4 of the sheet (see FIG. 2). More specifically, each line head 31 has a length in the width direction D5 that corresponds to a width of the largest size sheet that can be stored in the sheet feed cassette 11. The four line heads 31 are provided side by side at equal intervals along the conveying direction D4.

In the image forming apparatus 100, four colors of ink, namely black, cyan, magenta, and yellow, are used to form an image. The ink is a water-based ink with water as the main solvent. Four line heads 31 are provided corresponding to the four ink colors.

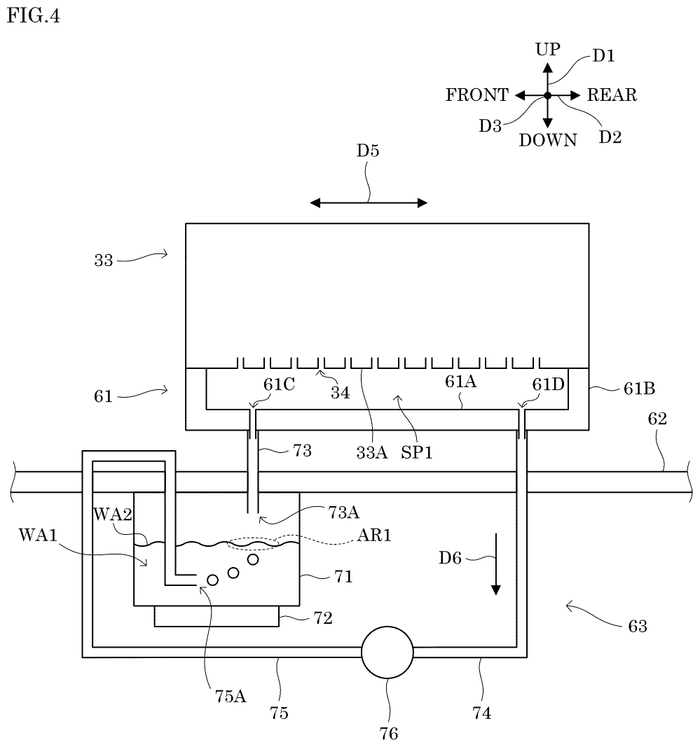

As shown in FIG. 2, each line head 31 includes three recording heads 33. The recording head 33 ejects ink toward the sheet conveyed by the conveying unit 22. More specifically, a large number of nozzles 34 (see FIG. 4) used for ejecting ink are provided on an opposing surface (bottom surface) of the recording head 33 that faces the sheet. The recording head 33 ejects ink from each of the nozzles 34. Hereinafter, the surface of the recording head 33 on which the nozzles 34 are formed will be referred to as a “nozzle surface 33A” (see FIGS. 1 and 4). The recording head 33 is an example of an ejection portion according to the present disclosure.

As shown in FIG. 2, in each line head 31, three recording heads 33 are arranged in a staggered manner along the width direction D5.

The support portion 32 supports the four line heads 31. As shown in FIG. 2, the support portion 32 is formed in a flat plate shape along a horizontal plane. The support portion 32 includes mounting portions corresponding to the recording heads 33. The mounting portion includes a through hole that passes through the support portion 32 in the up-down direction D1. The bottom portion, including the nozzle surface 33A, of the recording head 33 mounted in the mounting portion protrudes downward from the through hole of the mounting portion (see FIG. 1).

The head unit 21 is provided so as to be movable between an image forming position and a retreat position. In FIG. 1, the head unit 21 arranged at the image forming position is indicated by a solid line. In addition, in FIG. 1, the head unit 21 arranged at the retreat position is indicated by a dashed line. The image forming position is the position at which the head unit 21 is arranged when an image forming process for forming an image on a sheet is executed. The retreat position is a position above the image forming position, and is a position retreated above the movement path of a wiping unit 52 (see FIG. 1) and a cap unit 53 (see FIG. 1), which move along the left-right direction D3. In other words, the head unit 21 is provided so as to be movable in the up-down direction D1.

More specifically, the support portion 32 is supported by a housing of the image forming apparatus 100 so as to be movable in the up-down direction D1. The support portion 32 receives a driving force supplied from a driving portion (not shown) and moves in the up-down direction D1. As the support portion 32 moves, the four line heads 31 supported by the support portion 32 also move.

Note that the number of line heads 31 provided in the head unit 21 does not need to be limited to four. In addition, the number of recording heads 33 included in the line head 31 does not need to be limited to three.

As shown in FIG. 1, the conveying unit 22 is arranged below the head unit 21. The conveying unit 22 conveys the sheet while facing the recording head 33. As shown in FIG. 1, the conveying unit 22 includes a conveying belt 41 on which a sheet is placed, and a plurality of tension rollers for tensioning the conveying belt 41. Note that a gap between the conveying belt 41 and the nozzle surface 33A of the recording head 33 is adjusted so that the gap between the surface of the sheet and the nozzle surface 33A during image formation is a predetermined distance (for example, 1 mm).

The maintenance portion 3 is used for maintenance of the head unit 21.

As shown in FIG. 1, the maintenance portion 3 includes a housing portion 51, a wiping unit 52, and a cap unit 53.

As shown in FIG. 1, the housing portion 51 is arranged farther on a side in the left direction than the image forming portion 2. The housing portion 51 houses the wiping unit 52 and the cap unit 53. The housing portion 51 is formed in a hollow rectangular parallelepiped shape that is open on a side in the right direction.

The wiping unit 52 executes a wiping process to wipe the nozzle surface 33A. The wiping unit 52 includes wiping portions corresponding to the recording heads 33, and support portions that support the wiping portions. The support portion is formed in a flat plate shape along a horizontal plane. Each of the wiping portions is arranged on an upper surface of the support portion.

The wiping unit 52 is provided so as to be movable between a first housing position and a wiping position. FIG. 1 shows the wiping unit 52 arranged at the first housing position. As shown in FIG. 1, the first housing position is a position where the wiping unit 52 is housed in the housing portion 51. The wiping position is the position at which the wiping unit 52 is arranged when the wiping process is executed. The wiping position is a position on the right side of the first housing position. In addition, the wiping position is a position between the image forming position and the retreat position. That is, the wiping unit 52 is provided so as to be movable in the left-right direction D3.

More specifically, the support portion of the wipe unit 52 is supported by the housing of the image forming apparatus 100 so as to be movable in the left-right direction D3. The support portion receives a driving force supplied from a driving portion (not shown) and moves in the left-right direction D3.

In the image forming apparatus 100, in a case in which the wiping process is executed, the operating mode of the image forming apparatus 100 transitions from an image formation mode in which the image formation process can be executed to a wiping mode in which the wiping process can be executed according to the following procedure. First, the head unit 21 is moved from the image forming position to the retreat position. Next, the wiping unit 52 is moved from the first housing position to the wiping position. The head unit 21 is moved downward from the retreat position until the nozzle surface 33A and the wiping portion of the wiping unit 52 come into contact with each other. Thus, it possible to carry out the wiping process.

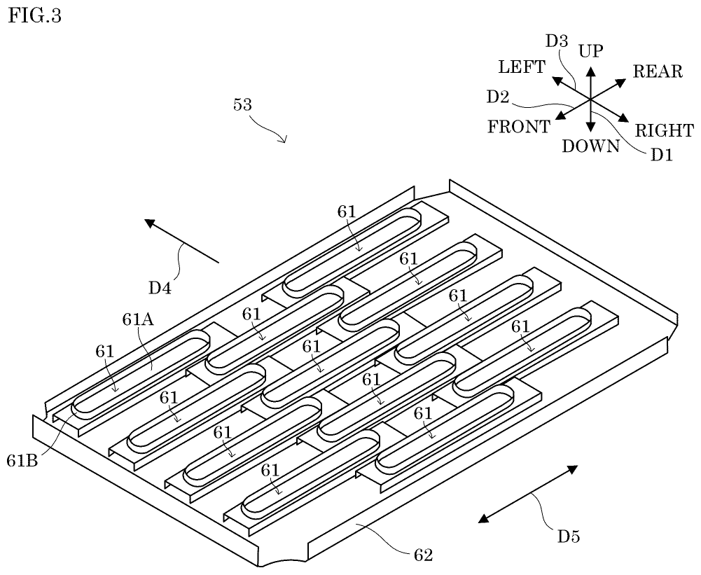

The cap unit 53 caps the nozzle surface 33A. As shown in FIG. 3, the cap unit 53 includes cap portions 61 corresponding to the recording heads 33, and a support portion 62 that support the cap portions 61. As shown in FIG. 3, the support portion 62 is formed in a flat plate shape along a horizontal plane. The support portion 62 is made of metal. The cap portions 61 are arranged on an upper surface of the support portion 62. The cap portions 61 seal a space along the nozzle surfaces 33A. In other words, the cap portions 61 cap the nozzle surfaces 33A. As shown in FIG. 3, the cap portion 61 includes a bottom surface portion 61A and a peripheral wall portion 61B. The bottom surface portion 61A forms an opposing surface facing the nozzle surface 33A. The peripheral wall portion 61B is formed along an edge portion of the bottom surface portion 61A. The peripheral wall portion 61B, by surrounding a space between the nozzle surface 33A and the bottom surface portion 61A on all four sides (front, back, left and right), seals the space. The cap portion 61 is formed from an elastically deformable material such as rubber. In a case in which the nozzle surface 33A is capped, the cap portion 61 is pressed against the nozzle surface 33A from below the nozzle surface 33A. Thus, a sealed space SP1 (see FIG. 4) is formed that is surrounded by the nozzle surface 33A, the bottom surface portion 61A, and the peripheral wall portion 61B. The cap portion 61 is an example of a sealing portion according to the present disclosure.

The cap unit 53 is provided to be movable between a second housing position and the cap position. FIG. 1 shows the cap unit 53 arranged at the second housing position. As shown in FIG. 1, the second housing position is a position where the cap unit 53 is housed in the housing portion 51. The cap position is a position where the cap portion 61 covers the space along the nozzle surface 33A. The cap position is a position on the right side of the second housing position. In addition, the cap position is a position between the image forming position and the retreat position. In other words, the cap unit 53 is provided to be movable in the left-right direction D3. The second housing position is also a position retreated from the cap position. The cap position is an example of a first position according to the present disclosure. The second housing position is an example of a second position according to the present disclosure.

More specifically, the support portion 62 of the cap unit 53 is supported by the housing of the image forming apparatus 100 so as to be movable in the left-right direction D3. The support portion 62 receives a driving force supplied from a driving portion (not shown) and moves in the left-right direction D3.

In the image forming apparatus 100, in a case in which the nozzle surface 33A is capped, the operation mode of the image forming apparatus 100 transitions from the image formation mode to a cap mode in which the nozzle surface 33A is capped according to the following procedure. First, the head unit 21 is moved from the image forming position to the retreat position. Next, the cap unit 53 is moved from the second housing position to the cap position. The head unit 21 is moved downward from the retreat position until the nozzle surface 33A is pressed against the cap portion 61 of the cap unit 53. Thus, the nozzle surface 33A is capped.

In the cap mode, humidified air is supplied into the sealed space SP1 (see FIG. 4) sealed by the cap portion 61.

More specifically, the cap unit 53 includes a humidifying portion 63 (see FIG. 4) corresponding to each of the recording heads 33.

### Configuration of the Humidifying Portion 63

Next, a configuration of the humidifying portion 63 will be described with reference to FIG. 4. Here, FIG. 4 is a cross-sectional view showing the cap portion 61 and the humidifying portion 63 in a state in which the nozzle surface 33A is capped.

The humidifying portion 63 supplies humidified air into the sealed space SP1 (see FIG. 4) sealed by the cap 61.

As shown in FIG. 4, the humidifying portion 63 includes a tank 71, a heater 72, a first air passage 73, a second air passage 74, a third air passage 75, and a pump 76.

The tank 71 stores water WA1 (see FIG. 4).

As shown in FIG. 4, the tank 71 is attached to a bottom surface of the support portion 62. The tank 71 is formed in a hollow rectangular parallelepiped shape with an open upper side. The tank 71 is attached to the bottom surface of the support portion 62 so that the upper opening is closed by the bottom surface of the support portion 62. A predetermined amount of water WA1 is stored in the tank 71.

The heater 72 heats the water WA1 stored in the tank 71.

As shown in FIG. 4, the heater 72 is provided on an outer surface of the tank 71. The heater 72 generates heat in response to a power supply. Driving of the heater 72 is controlled by a control portion (not shown). More specifically, the control portion controls driving of the heater 72 so that the temperature of the water WA1 in the tank 71 detected by a temperature sensor (not shown) becomes a predetermined temperature.

The first air passage 73 is an air movement passage from an upper space above a water surface WA2 (see FIG. 4) of the water WA1 stored in the tank 71 to a through hole 61C (see FIG. 4) formed in a bottom surface portion 61A of the cap portion 61. For example, the first air passage 73 is a resin tube that extends from the through hole 61C through a through hole formed in the support portion 62 into the tank 71. An end on the tank 71 side of the first air passage 73 forms an intake port 73A (see FIG. 4) that opens above the water surface WA2 of the water WA1 stored in the tank 71.

The second air passage 74 is a passage through which air travels from the through hole 61D (see FIG. 4) formed in the bottom surface portion 61A of the cap portion 61 to the pump 76. For example, the second air passage 74 is a resin tube that extends from the through hole 61D through a through hole formed in the support portion 62 to the inside of the pump 76.

The third air passage 75 is a passage through which air travels from the pump 76 to the water below the water surface WA2 (see FIG. 4) of the water WA1 stored in the tank 71. For example, the third air passage 75 is a resin tube that extends from the pump 76 through two through holes formed in the support portion 62 into the tank 71. The end on the tank 71 side of the third air passage 75 forms an exhaust port 75A (see FIG. 4) that opens below the water surface WA2 of the water WA1 stored in the tank 71.

As shown in FIG. 4, the first air passage 73, the cap portion 61, the nozzle surface 33A of the recording head 33, the second air passage 74, the pump 76, and the third air passage 75 form an air movement path from the intake port 73A through the sealed space SP1 to the exhaust port 75A. The first air passage 73, the cap portion 61, the nozzle surface 33A of the recording head 33, the second air passage 74, the pump 76, and the third air passage 75 are an example of a path forming portion according to the present disclosure. Moreover, the intake port 73A is an example of a first opening portion according to the present disclosure. In addition, the exhaust port 75A is an example of a second opening portion according to the present disclosure.

The pump 76 moves air in the air movement path from the intake port 73A through the sealed space SP1 to the exhaust port 75A in a movement direction D6 (see FIG. 4) from the intake port 73A to the exhaust port 75A. Note that the third air passage 75 is provided with a check valve (not shown) for preventing the water WA1 in the tank 71 from flowing back toward the pump 76 side.

In the humidifying portion 63, air is discharged from the exhaust port 75A by driving the pump 76, and the discharged air is heated and humidified in the water WA1 and rises above the water surface WA2 to generate humidified air. The generated humidified air is supplied to the sealed space SP1 via the first air passage 73. Thus, the ink in the nozzles 34 is prevented from drying out while the nozzle surface 33A is capped.

In a case in which there is futility in the movement path of the humidified air from the water surface WA2 to the intake port 73A, the temperature of the humidified air will drop unnecessarily until the humidified air is supplied to the sealed space SP1. For example, when the humidified air that has risen above the water surface WA2 comes into contact with the metallic support portion 62 before moving to the intake port 73A, the temperature of the humidified air will drop. When the temperature of the humidified air supplied to the sealed space SP1 drops, the humidity in the sealed space SP1 drops, and the drying of the ink in the nozzles 34 cannot be sufficiently suppressed.

In contrast, in the image forming apparatus 100 of an embodiment according to the present disclosure, as will be described below, it is possible to suppress a decrease in the temperature of the humidified air supplied to the sealed space SP1.

More specifically, in the humidifying portion 63, the intake port 73A and the exhaust port 75A are arranged in a positional relationship such that the intake port 73A faces a specific range AR1 (see FIG. 4) on the water surface WA2 where the air discharged from the exhaust port 75A rises up. Thus, it is possible to eliminate futility from the movement path of humidified air from the water surface WA2 to the intake port 73A. Note that in FIG. 4, the specific range AR1 is indicated by a dashed line.

The specific range AR1 may be determined based on the depth of the position of the exhaust port 75A (the distance in the up-down direction D1 from the water surface WA2), the orientation of the exhaust port 75A, and the wind speed in the third air passage 75 when air is discharged from the exhaust port 75A by the pump 76. In addition, the specific range AR1 may be identified based on the results of an experiment investigating the position on the water surface WA2 where the air discharged from the exhaust port 75A by the pump 76 rises.

It is desirable for the intake port 73A to open downward at the upper side near the center of the specific range AR1. Thus, it is possible to efficiently draw in the humidified air generated in the specific range AR1.

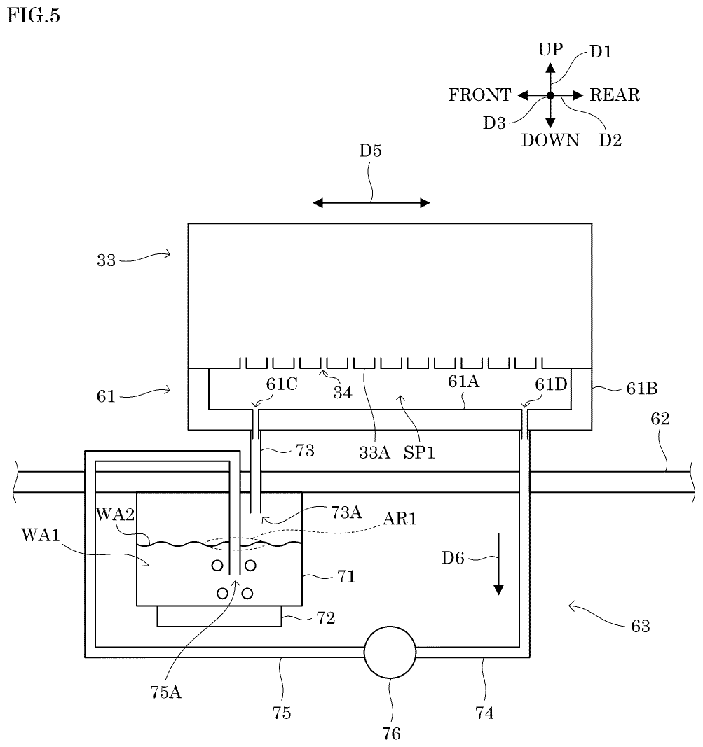

Here, in the image forming apparatus 100, the exhaust port 75A is provided so as to open in a direction crossing the vertical direction. More specifically, as shown in FIG. 4, the exhaust port 75A opens toward the rear side of the image forming apparatus 100. Thus, as shown in FIG. 5, it is possible to separate the specific range AR1 away from the exhaust port 75A in a direction along the horizontal plane, compared to a configuration in which the exhaust port 75A opens in a direction along the vertical direction (upward or downward). In other words, it is possible to increase the distance between the intake port 73A and the exhaust port 75A in the direction along the horizontal plane, and it is possible to increase the degree of freedom in the arrangement of the intake port 73A and the exhaust port 75A.

In addition, in the image forming apparatus 100, the tank 71 is attached to the support portion 62 of the cap portion 61. In other words, the tank 71 is provided so as to be movable integrally with the cap portion 61. Thus, it is possible to reduce the distance between the tank 71 and the cap portion 61 compared to a configuration in which the tank 71 is fixedly arranged within the housing of the image forming apparatus 100. In other words, it is possible to shorten the supply path of humidified air from the tank 71 to the cap portion 61. Therefore, compared to a configuration in which the tank 71 is fixedly arranged within the housing of the image forming apparatus 100, it is possible to suppress a decrease in the temperature of the humidified air supplied to the sealed space SP1.

Note that the humidifying portion 63 may be provided for each line head 31. In this case, the first air passage 73 may be configured to communicate between the tank 71 and each of the recording heads 33 included in the line head 31. In addition, the second air passage 74 may be configured to communicate between each of the recording heads 33 included in the line head 31 and the pump 76.

### Supplementary Notes

An outline of the invention extracted from the above-described embodiment will be added below. Note that the configurations and processing functions described in the following supplementary notes can be selected and combined as desired.

### Supplementary Note 1

A liquid ejection apparatus, including:
an ejection portion having a nozzle surface on which nozzles are formed and configured to eject liquid from the nozzles;
a sealing portion configured to seal a space along the nozzle surface;
a tank configured to store water;
a heater configured to heat the water stored in the tank;
a path forming portion configured to form a movement path for air to move from a first opening portion that opens above a water surface of the water stored in the tank, through a sealed space sealed by the sealing portion, to a second opening portion that opens below the water surface; and
a pump configured to move air in the movement path in a direction from the first opening portion toward the second opening portion; wherein
the first opening portion and the second opening portion are arranged in a positional relationship such that the first opening portion faces a specific range on the water surface to which air discharged from the second opening portion rises.

### Supplementary Note 2

The liquid ejection apparatus according to Supplementary Note 1, wherein
the second opening portion is open in a direction crossing a vertical direction.

### Supplementary Note 3

The liquid ejection apparatus according to Supplementary Note 1 or 2, wherein
the sealing portion includes a cap portion that is provided to be movable between a first position that covers a space along the nozzle surface and a second position that is retreated from the first position; and
the tank is provided so as to be movable integrally with the cap portion.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A liquid ejection apparatus, comprising:
an ejection portion having a nozzle surface on which nozzles are formed and configured to eject liquid from the nozzles;
a sealing portion configured to seal a space along the nozzle surface;
a tank configured to store water;
a heater configured to heat the water stored in the tank;
a path forming portion configured to form a movement path for air to move from a first opening portion that opens above a water surface of the water stored in the tank, through a sealed space sealed by the sealing portion, to a second opening portion that opens below the water surface; and
a pump configured to move air in the movement path in a direction from the first opening portion toward the second opening portion; wherein
the first opening portion and the second opening portion are arranged in a positional relationship such that the first opening portion faces a specific range on the water surface to which air discharged from the second opening portion rises.

2. The liquid ejection apparatus according to claim 1, wherein
the second opening portion is open in a direction crossing a vertical direction.

3. The liquid ejection apparatus according to claim 1, wherein
the sealing portion includes a cap portion that is provided to be movable between a first position that covers a space along the nozzle surface and a second position that is retreated from the first position; and
the tank is provided so as to be movable integrally with the cap portion.
